(19) United States
(12) Patent Application Publication
(10) Pub. No.: US 2015/0195834 A1
(43) Pub. Date: Jul. 9, 2015

(54) METHOD AND APPARATUS FOR MANAGING PAIRING BETWEEN MOBILE STATIONS IN WIRELESS COMMUNICATION SYSTEM

(71) Applicant: Samsung Electronics Co., Ltd., Gyeonggi-do (KR)

(72) Inventors: Jae-Yun Ko, Gyeonggi-do (KR); Se-Ho Kim, Seoul (KR); Yun-Seok Choi, Daegu (KR); Keun-Chul Hwang, Gyeonggi-do (KR)

(21) Appl. No.: 14/591,744

(22) Filed: Jan. 7, 2015

(30) Foreign Application Priority Data
Jan. 7, 2014 (KR) 10-2014-0001620

(51) Int. Cl. H04W 72/04; H04W 52/26; H04W 72/08; H04W 52/24

(52) U.S. Cl. CPC H04W 72/0446; H04W 52/241; H04W 52/267; H04W 72/082; H04W 88/08

(57) ABSTRACT

A method for managing pairing between a plurality of mobile stations sharing one time slot in a wireless communication system is provided. The method includes selecting candidate mobile stations to share one time slot. The method also includes checking an occurrence of power racing using a code rate and an availability of the candidate mobile stations. The method further includes determining whether to perform pairing that enables the candidate mobile stations to share the one time slot, based on results from checking the occurrence of the power racing.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Jan. 7, 2014 and assigned Serial No. 10-2014-0001620, the entire disclosure of which is incorporated herein by reference.

### TECHNICAL FIELD

The present disclosure relates to a method and apparatus for managing pairing between mobile stations in a voice services over adaptive multi-user channels on one slot (VAMOS) wireless communication system in which a plurality of mobile stations share one time slot.

### BACKGROUND

Due to the recent surge in demand for mobile voice services, a Global System for Mobile Communications (GSM) network has been developed rapidly. As a result, it is increasingly difficult to meet the communication needs of people with the limited spectrum resources especially in populous cities. In addition, due to the increasing aging of the GSM network devices, it is very urgent to expand the GSM network capacity. However, from the viewpoint of the operator, since the voice service charge is lowered slightly each year, it is necessary to more efficiently reuse the current hardware resources and frequency resources. Therefore, it is very important to improve the system capacity without increasing the current system frequency resources.

### SUMMARY

To address the above-discussed deficiencies, it is a primary object to provide at least the advantages described below. Accordingly, an aspect of an embodiment of the present disclosure is to provide a method and apparatus for determining whether power racing by selected pairing candidate mobile stations occurs before pairing mobile stations in a VAMOS system.

Another aspect of an embodiment of the present disclosure is to provide a method and apparatus for determining whether power racing occurs in paired mobile stations in a VAMOS system. Another embodiment of an embodiment of the present disclosure is to provide a method and apparatus for releasing the pairing between paired mobile stations in a VAMOS system.

In a first example, a method for managing pairing between a plurality of mobile stations sharing one time slot in a wireless communication system is provided. The method includes selecting a plurality of candidate mobile stations to share one time slot. The method also includes checking an occurrence of power racing using a code rate and an availability of the candidate mobile stations. The method further includes determining whether to perform pairing that enables the candidate mobile stations to share the one time slot based on the check results. The checking of the occurrence of power racing includes determining whether the following equation is satisfied:

K=SINR_req_dB(1)+SINR_req_dB(2)+Delta_dB(1)+Delta_dB(2)+M<0,

where SINR_req_dB(i) (i=1,2) represents a Signal to Interference plus Noise Ratio (SINR) that should be satisfied for a service quality required for an i-th mobile station, and Delta_dB(i) (i=1,2) represents a ratio of power that acts as an interference to an i-th mobile station to received signal power of a counterpart mobile station paired with the i-th mobile station.

Determining whether to perform pairing includes performing pairing between the candidate mobile stations, if K<0. Determining whether to perform pairing also includes performing no pairing between the candidate mobile stations, if K>=0.

The method further includes, if pairing between the candidate mobile stations is performed, checking an occurrence of power racing after the pairing using a received signal strength indicator and a bit error rate of the paired mobile stations. The method includes releasing the pairing between the mobile stations, if power racing occurs after the pairing. The releasing of the pairing between the mobile stations includes releasing the pairing between the mobile stations, if at least one of the paired mobile stations causes the occurrence of power racing after the pairing. The checking of the occurrence of power racing after the pairing includes checking whether the following equation is satisfied,

RXLEV>TH_LEV and RXQUAL>TH_QUAL,

where RXLEV represents a received signal level at a mobile station, TH_LEV represents a reference value of RXLEV, RXQUAL represents a received signal quality at the mobile station, and TH_QUAL represents a reference value of RXQUAL.

In a second example, an apparatus for managing pairing between a plurality of mobile stations sharing one time slot in a wireless communication system is provided. The apparatus includes a controller. The controller is configured to select candidate mobile stations that will share one time slot. The apparatus also includes a power racing determination unit. The power racing determination unit is configured to check occurrence of power racing using a code rate and an availability of the candidate mobile stations. The controller determines whether to perform pairing that enables the candidate mobile stations to share the one time slot, based on the check results.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example VAMOS system and an example VAMOS system operation according to this disclosure;

FIG. 2 illustrates an example operation of a base station according to this disclosure; and

FIG. 3 illustrates an example structure of a base station according this disclosure.

Throughout the drawings, like reference numerals will be understood to refer to like parts, components, and structures.

### DETAILED DESCRIPTION

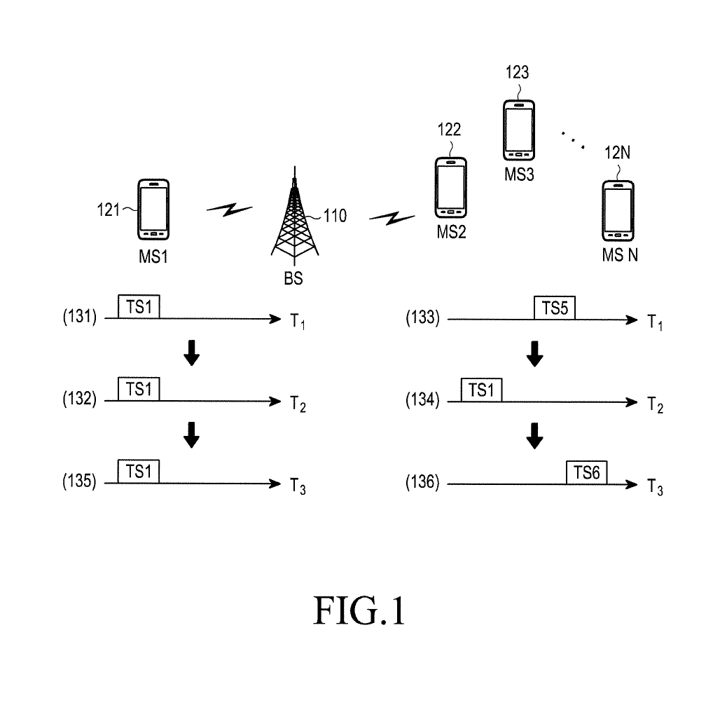

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device or telecommunications system. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skilled in the art will recognize that various changes and modifications of the embodiments described herein can be made without departing from the scope and spirit of the disclosure. In addition, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, occurs in amounts that do not preclude the effect the characteristic was intended to provide.

The basic concept of an embodiment of the present disclosure is to check in advance whether power racing between a plurality of mobile stations occurs before VAMOS pairing in a VAMOS system, and to pair the mobile stations if the power racing does not occur. In addition, even after the mobile stations are paired, a base station check whether power racing between the paired mobile stations occurs, and release the pairing between the mobile stations if the power racing occurs.

Multiple User Reuse One Slot (MUROS) technology for enabling a plurality of users to reuse one slot is mainly applied to 3GPP GSM/Enhanced Data rates for GSM Evolution (EDGE) Radio Access Network (GERAN). The MUROS technology was officially named ‘Voice services over Adaptive Multi-user channels on One Slot (VAMOS)’ in the GERAN#40 conference held in November 2008. In other words, VAMOS supports voice services for a plurality of mobile stations using one time slot.

In the VAMOS system, assigning one time slot to a plurality of mobile stations so that they shares the time slot is referred to as ‘pairing’. However, if a plurality of mobile stations are paired in this way and supported by a voice service over one time slot, one mobile station is interfered with by another mobile station paired therewith. In this case, power racing occurs between the paired mobile stations. If the power racing occurs, the communication service may not be properly provided to the mobile stations.

For a better understanding, an example of power racing will be described. Assuming that a base station has paired a first mobile station and a second mobile station, the first mobile station will receive a signal that the base station transmitted to the first mobile station, and an interference signal that the base station transmitted to the second mobile station. If a Signal to Interference plus Noise Ratio (SINR) of the signal that the first mobile station has received does not reach the SINR required for the reception by the interference signal, the first mobile station requests the base station to increase the power of the transmission signal, and in response to the request, the base station increases the power of the transmission signal for the first mobile station. On the other hand, in the same manner, the base station increases the power of the transmission signal even for the second mobile station. In this case, due to the interference signal between the first mobile station and the second mobile station, each of the first mobile station and the second mobile station sends a request for increasing the power of the transmission signal to the base station, and in response to the request, the base station increases the power of the transmission signal for the first mobile station and the second mobile station. However, as the base station increases the transmission power for the first mobile station more and more, the interference signal from the second mobile station by the signal transmitted to the first mobile station also increases more and more. In the same manner, as the base station increases the transmission power for the second mobile station more and more, the interference signal from the first mobile station by the signal transmitted to the second mobile station also increases more and more. Due to the mutual interference between the mobile stations, even though the base station increases the transmission power of the signals that the base station transmits to the mobile stations, in a competitive way, SINR of the signals that the mobile stations have received may not reach the required SINR. This phenomenon is referred to as ‘power racing’.

FIG. 1 illustrates an example VAMOS system and an example VAMOS system operation according to this disclosure.

As described above, in the VAMOS system, one time slot is assigned to a plurality of mobile stations. However, it is assumed in FIG. 1 that only two mobile stations simultaneously receive a communication service over one time slot.

Referring to FIG. 1, N mobile stations (MSs) 121, 122, 123, . . . , 12N are present in the cell area managed by a base station (BS) 110, and the mobile stations 121, 122, 123, . . . , 12N receive a communication service using different time slots. It will be assumed that the base station 110 has determined the second mobile station 122 among the (N−1) mobile stations 122, 123, . . . , 12N as a candidate mobile station to be paired with the first mobile station 121.

In this situation, time slots are assigned to the first mobile station 121 and the second mobile station 122 over time, as follows.

First, the first mobile station 121 has been assigned a first time slot at time T1 (131), and the second mobile station 122 has been assigned a fifth time slot at time T1 (133). The base station 110 has determined the second mobile station 122 as a pairing candidate mobile station for the first mobile station 121. In a pairing method, the base station 110 assigns the first time slot to the first mobile station 121 and the second mobile station 122 at time T2 (132 and 134).

On the other hand, in an embodiment of the present disclosure, the base station 110 checks whether power racing will occur between mobile stations to be paired, before pairing the mobile stations. In other words, the base station 110 checks whether power racing will occur, before pairing the first mobile station 121 and the second mobile station 122 (such as during the time between time T1 and time T2), using predetermined conditions (hereinafter, referred to as ‘power racing pre-check conditions’). Accordingly, if it is determined that power racing will not occur between the first mobile station 121 and the second mobile station 122, then the base station 110 pairs the first mobile station 121 and the second mobile station 122.

After being paired, the first mobile station 121 and the second mobile station 122 receive the communication service over the same time slot. In an embodiment of the present disclosure, even for the paired mobile stations, the base station re-checks whether power racing occurs after the pairing, using predetermined conditions (hereinafter, referred to as ‘power racing post-check conditions’). If power racing occurs, the base station releases the pairing between the mobile stations. For example, after the first mobile station 121 and the second mobile station 122 are paired, the base station 110 determines whether power racing occurs between them, and if it is determined that power racing has occurred, the base station 110 releases the pairing between the first mobile station 121 and the second mobile station 122. For reference, checking whether power racing occurs after the pairing is performed at stated periods, or performed aperiodically (such as upon occurrence of a specific event set by the system). In the example of FIG. 1, the base station 110 releases the pairing between the first mobile station 121 and the second mobile station 122 at time T3, so that the first mobile station 121 uses the first time slot at time T3 (135) and the second mobile station 122 uses a sixth time slot at time T3 (136).

As described above, in an embodiment of the present disclosure, the base station checks whether power racing occurs, before and after the pairing between the mobile stations. Hereinafter, for convenience of description, checking whether power racing occurs, which is performed before the pairing and after the pairing will be referred to as ‘power racing pre-check’ and ‘power racing post-check’, respectively.

The power racing pre-check conditions are described herein. The power racing pre-check conditions is expressed by Equation (1) below.

K=SINR_req_dB(1)+SINR_req_dB(2)+Delta_dB(1)+Delta_dB(2)+M<0 (1)

It is assumed in Equation (1) that two mobile stations are paired. In this case, K is determined by the sum of four components. If Equation (1) is satisfied (such as K<0), it means that power racing does not occur if the two mobile stations are paired.

SINR_req_dB(i) (i=1,2) among the components of K represents a Signal to Interference plus Noise Ratio (SINR) that should be satisfied for the service quality required for an i-th mobile station, and the base station determines this value depending on the code rate of the mobile station. Delta_dB(i) (i=1,2) among the components of K represents a ratio of the power that acts as an interference to an i-th mobile station, to the received signal power of a counterpart mobile station paired with the i-th mobile station. For example, if Delta(1)=−10 dB (0.1), it means that 10% of the received power of the second mobile station, which is the counterpart mobile station paired with the first mobile station, acts as an interference to the first mobile station. This value is a value that is determined by the base station depending on the reception performance of the i-th mobile station, and is determined depending on the mobile station's capability value that the mobile station has reported to the base station in the mobile station's call setup process with the base station. Table 1 below is an example for determining Delta_dB(i) by the base station depending on the mobile station's reception performance. In Table 1, Delta1, . . . , Delta9 are the values that the base station determine in advance in a predetermined optimization process.

TABLE 1

| Downlink Advanced | | |
|---|---|---|
| Receiver Performance | VAMOS Level | Delta_dB(i) |
| 0 | 0 | Delta1 |
| | 1 | Delta2 |
| | 2 | Delta3 |
| 1 | 0 | Delta4 |
| | 1 | Delta5 |
| | 2 | Delta6 |
| 2 | 0 | Delta7 |
| | 1 | Delta8 |
| | 2 | Delta9 |

For reference, in Table 1, “Downlink Advanced Receiver Performance” and “VAMOS Level” are the values that the mobile station reports to the base station in the call setup process, and are included in Class Mark 3. Referring to back to Equation (1), “M” in K represents a margin value for the power racing check, and is a constant value that is adjusted depending on the system settings.

In Equation (1), SINR_req_dB(1) and SINR_req_dB(2) usually have a positive value. Delta_dB(1) and Delta_dB(2) have a negative value. Margin (M) has a positive value. In other words, as an absolute value of Delta_dB(1)+Delta_dB(2) meaning a degree of the mutual interference between mobile stations is larger (such as the interference component is smaller), a value of K becomes a negative value, and as the absolute value is smaller, the value of K becomes a positive value. In other words, as the interference component in K is smaller, K will have a negative value, and as the interference component in K is larger, K will have a positive value. Therefore, for the two mobile stations, if a value of K is less than 0, the base station performs pairing since power racing will not occur, and if the value of K is greater than or equal to 0, the base station may not pair the two mobile stations since power racing will occur. However, by adjusting the margin value (M) in K, it is possible to give a margin in determining whether to perform pairing.

For the two mobile stations that do not satisfy the power racing pre-check conditions by Equation (1), even though the base station increases the transmission power for the mobile stations after the pairing, the base station may not satisfy the SINR required from the mobile stations. Therefore, if the pairing candidate mobile stations do not satisfy Equation (1), the base station may not actually perform pairing for the two pairing candidate mobile stations, considering that the pairing between the two pairing candidate mobile stations is failed. On the contrary, if the pairing candidate mobile stations satisfy Equation (1), the base station actually performs pairing for the pairing candidate mobile stations, determining that the pairing between the pairing candidate mobile stations will be successful.

The power racing post-check conditions are described herein. Even though the base station has checked in advance whether power racing occurs through the power racing pre-check, power racing occurs even after the pairing, due to an error between the estimated delta value and the actual delta value. Therefore, the base station determines whether power racing occurs even after the pairing, and if power racing occurs, releases the pairing between the paired mobile stations. The power racing post-check conditions is expressed by Equation (2) below.

RXLEV>TH_LEV and RXQUAL>TH_QUAL (2)

RXLEV means a received signal level at a mobile station. Usually, it is expressed as a quantized value of a Received Signal Strength Indicator (RSSI). TH_LEV represents a reference value (or a threshold value) of the RXLEV. RXQUAL means a received signal quality at the mobile station. Usually, it is expressed as a quantized value of a Bit Error Rate (BER). TH_QUAL represents a reference value (or a threshold value) of the RXQUAL. Large RXQUAL means that a received signal has many errors. Thus, as a RXQUAL value is larger, the quality of the received signal is worse. For reference, the RXLEV and RXQUAL values are both the values that the mobile station reports to the base station. On the other hand, TH_LEV and TH_QUAL is determined in advance by the base station in the optimization process.

Satisfying Equation (2) means that the received signal level RXLEV is greater than the reference value TH_LEV but the badness RXQUAL of the received signal quality exceeds the reference value TH_QUAL. This means that a signal received at the mobile station has many interference signals. In the VAMOS system, most interference signals are generated from the VAMOS-paired counterpart mobile station. Thus, if the received signal has interference signals more than a predetermined number, it means that interference of a predetermined amount or more has occurred between the VAMOS-paired mobile stations. Therefore, after the pairing, if any one of the paired mobile stations satisfies Equation (2), the base station releases the pairing between the mobile stations.

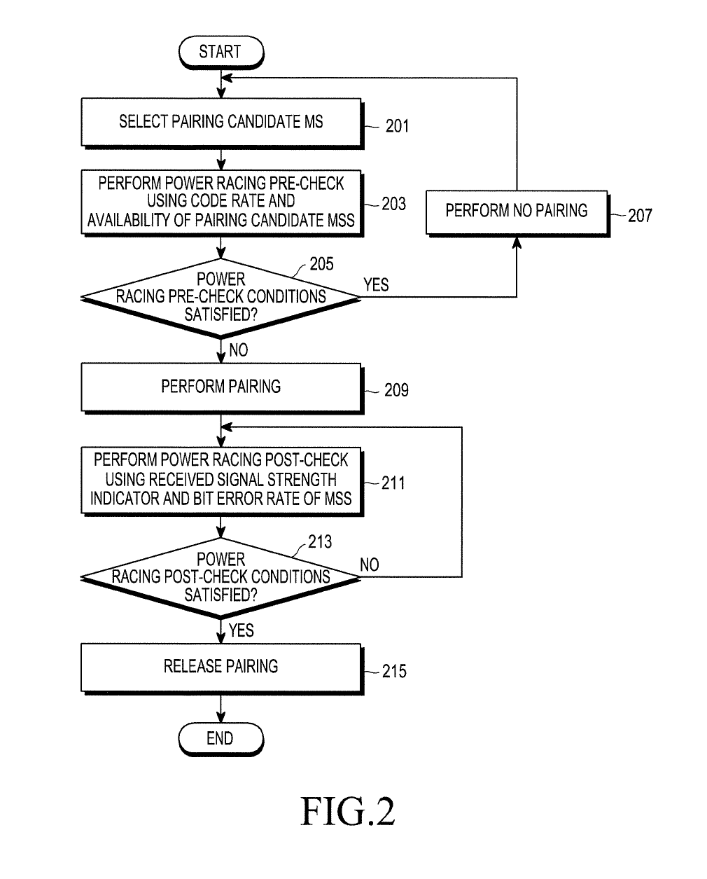

FIG. 2 illustrates an example operation of a base station according to this disclosure. In operation 201, the base station selects pairing candidate mobile stations. Since the criteria for selecting the pairing candidate mobile stations are not the subject matter of the present disclosure, a detailed description thereof will be omitted.

In operation 203, the base station performs power racing pre-check by Equation (1) using a code rate and an availability of the selected pairing candidate mobile stations. Although the code rate and availability of the mobile stations is what the base station has obtained in the call setup process with the mobile stations, the base station will not be limited in obtaining that information in an embodiment of the present disclosure.

In operation 205, the base station determines whether the power racing pre-check conditions described in Equation (1) are satisfied. If the conditions are satisfied, the base station may not perform pairing between the pairing candidate mobile stations in operation 207. Thereafter, the base station determines again pairing candidate mobile stations back in operation 201. On the other hand, if the conditions are not satisfied, the base station performs pairing between the pairing candidate mobile stations in operation 209. In other words, in operations 205 to 209, the base station performs pairing if the value of K in Equation (1) is less than 0, and may not perform pairing if the value of K is greater than or equal to 0.

In operation 211, for the paired mobile stations, the base station performs the power racing post-check described in Equation (2) using the received signal strength indicator and bit error rate information of the mobile stations. In operation 213, the base station determines whether the power racing post-check conditions of Equation (2) are satisfied. If the conditions are not satisfied, the base station performs again the power racing post-check back in operation 211. However, the base station performs the power racing post-check at stated periods, or upon occurrence of a specific event set by the system. If the power racing post-check conditions are satisfied, the base station releases the pairing between the mobile stations in operation 215.

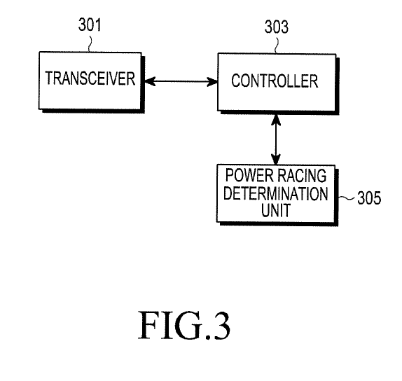

FIG. 3 illustrates an example structure of a base station according to this disclosure. Referring to FIG. 3, a transceiver 301 transmits and receives signals to or from mobile stations. In particular, the transceiver 301 obtains a code rate and an availability of pairing candidate mobile stations, for the power racing pre-check, and obtains the received signal strength indicator and bit error rate information, for the power racing post-check.

A controller 303 selects pairing candidate mobile stations, and controls the power racing pre-check and post-check operations. A power racing determination unit 305 performs the power racing pre-check and post-check, and deliver the check results to the controller 303. In other words, during the power racing pre-check, the power racing determination unit 305 performs the power racing pre-check by Equation (1) using the code rate and availability of the selected pairing candidate mobile stations. During the power racing post-check, the power racing determination unit 305 performs the power racing post-check by Equation (2) for the paired mobile stations, and deliver the check results to the controller 303.

An embodiment of the present disclosure has been described so far. According to an embodiment of the present disclosure, the base station blocks in advance the power racing between mobile stations before pairing between them in the VAMOS system, and after the pairing, the base station determines whether power racing occurs, using the received signal strength indicator and the signal quality of the mobile stations, to release the pairing between the mobile stations in which power racing has occurred. In this manner, the base station recognizes power racing before the pairing to prevent the unnecessary pairing operation, and if power racing is detected after the pairing, the base station prevents an increase in interference signal due to the power increase, thus preventing the call drop by the power racing. As a result, the degradation in sound quality is reduced.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for managing pairing between a plurality of mobile stations to share one time slot in a wireless communication system, the method comprising:
selecting candidate mobile stations to share one time slot;
checking an occurrence of power racing using a code rate and an availability of the candidate mobile stations; and
determining whether to perform pairing that enables the candidate mobile stations to share the one time slot, based on results from checking the occurrence of the power racing.

2. The method of claim 1, wherein the checking of the occurrence of the power racing comprises determining whether the following equation is satisfied,
K=SINR_req_dB(1)+SINR_req_dB(2)+Delta_dB(1)+Delta_dB(2)+M<0,
wherein the SINR_req_dB(i) (i=1,2) represents a Signal to Interference plus Noise Ratio (SINR) that should be satisfied for a service quality required for an i-th mobile station, and the Delta_dB(i) (i=1,2) represents a ratio of power that acts as an interference to an i-th mobile station to received signal power of a counterpart mobile station paired with the i-th mobile station.

3. The method of claim 2, wherein determining whether to perform pairing comprises:
performing pairing between the candidate mobile stations, if K<0; and
performing no pairing between the candidate mobile stations, if K>=0.

4. The method of claim 1, further comprising:
if pairing between the candidate mobile stations is performed, checking the occurrence of the power racing after the pairing using a received signal strength indicator and a bit error rate of the paired mobile stations; and
releasing the pairing between the mobile stations, if the power racing occurs after the pairing.

5. The method of claim 4, wherein releasing the pairing between the mobile stations comprises:
releasing the pairing between the mobile stations, if at least one of the paired mobile stations causes the occurrence of the power racing after the pairing.

6. The method of claim 4, wherein checking the occurrence of the power racing after the pairing comprises checking whether the following equation is satisfied,
RXLEV>TH_LEV and RXQUAL>TH_QUAL,
wherein the RXLEV represents a received signal level at a mobile station, the TH_LEV represents a reference value of the RXLEV, the RXQUAL represents a received signal quality at the mobile station, and the TH_QUAL represents a reference value of the RXQUAL.

7. An apparatus for managing pairing between a plurality of mobile stations to share one time slot in a wireless communication system, the apparatus comprising:
a controller configured to select candidate mobile stations to share one time slot; and
a power racing determination unit configured to check an occurrence of power racing using a code rate and an availability of the candidate mobile stations,
wherein the controller is configured to determine whether to perform pairing that enables the candidate mobile stations to share the one time slot, based on results from checking the occurrence of the power racing.

8. The apparatus of claim 7, wherein the power racing determination unit is configured to determine whether the following equation is satisfied,
K=SINR_req_dB(1)+SINR_req_dB(2)+Delta_dB(1)+Delta_dB(2)+M<0,
wherein the SINR_req_dB(i) (i=1,2) represents a Signal to Interference plus Noise Ratio (SINR) that should be satisfied for a service quality required for an i-th mobile station, and the Delta_dB(i) (i=1,2) represents a ratio of power that acts as an interference to an i-th mobile station to received signal power of a counterpart mobile station paired with the i-th mobile station.

9. The apparatus of claim 8, wherein the controller is configured to perform pairing between the candidate mobile stations, if K<0, and perform no pairing between the candidate mobile stations, if K>=0.

10. The apparatus of claim 7, wherein if pairing between the candidate mobile stations is performed, the power racing determination unit is configured to check the occurrence of the power racing after the pairing using a received signal strength indicator and a bit error rate of the paired mobile stations, and
wherein the controller is configured to release the pairing between the mobile stations, if the power racing occurs after the pairing.

11. The apparatus of claim 7, wherein the controller is configured to release the pairing between the mobile stations, if at least one of the paired mobile stations causes the occurrence of the power racing after the pairing.

12. The apparatus of claim 10, wherein the power racing determination unit is configured to check whether the following equation is satisfied,
RXLEV>TH_LEV and RXQUAL>TH_QUAL,
wherein the RXLEV represents a received signal level at a mobile station, the TH_LEV represents a reference value of RXLEV, the RXQUAL represents a received signal quality at the mobile station, and the TH_QUAL represents a reference value of RXQUAL.

13. A base station for managing pairing between a plurality of mobile stations to share one time slot in a wireless communication system, the base station comprising:
a controller configured to select candidate mobile stations to share one time slot; and
a power racing determination unit configured to check an occurrence of power racing using a code rate and an availability of the candidate mobile stations,
wherein the controller is configured to determine whether to perform pairing that enables the candidate mobile stations to share the one time slot, based on results from checking the occurrence of the power racing.

14. The base station of claim 13, wherein the power racing determination unit is configured to determine whether the following equation is satisfied,
K=SINR_req_dB(1)+SINR_req_dB(2)+Delta_dB(1)+Delta_dB(2)+M<0,
wherein the SINR_req_dB(i) (i=1,2) represents a Signal to Interference plus Noise Ratio (SINR) that should be satisfied for a service quality required for an i-th mobile station, and the Delta_dB(i) (i=1,2) represents a ratio of power that acts as an interference to an i-th mobile station to received signal power of a counterpart mobile station paired with the i-th mobile station.

15. The base station of claim 14, wherein the controller is configured to perform pairing between the candidate mobile stations, if K<0, and perform no pairing between the candidate mobile stations, if K>=0.

16. The base station of claim 13, wherein if pairing between the candidate mobile stations is performed, the power racing determination unit is configured to check the occurrence of the power racing after the pairing using a received signal strength indicator and a bit error rate of the paired mobile stations, and
wherein the controller is configured to release the pairing between the mobile stations, if the power racing occurs after the pairing.

17. The base station of claim 13, wherein the controller is configured to release the pairing between the mobile stations, if at least one of the paired mobile stations causes the occurrence of the power racing after the pairing.

18. The base station of claim 16, wherein the power racing determination unit is configured to check whether the following equation is satisfied,
RXLEV>TH_LEV and RXQUAL>TH_QUAL,
wherein the RXLEV represents a received signal level at a mobile station, the TH_LEV represents a reference value of RXLEV, the RXQUAL represents a received signal quality at the mobile station, and the TH_QUAL represents a reference value of RXQUAL.

19. The method of claim 1, wherein checking the occurrence of the power racing is performed at stated periods or aperiodically.

20. The apparatus of claim 7, wherein the power racing determination unit is configured to check the occurrence of the power racing at stated periods of aperiodically.
